(19) United States
(12) Patent Application Publication
(10) Pub. No.: US 2011/0177254 A1
(43) Pub. Date: Jul. 21, 2011

(54) METHOD OF MANUFACTURING FUNCTIONAL FILM

(75) Inventor: Eijirou IWASE, Ashigarakami-gun (JP)

(73) Assignee: FUJIFILM CORPORATION, Tokyo (JP)

(21) Appl. No.: 13/009,288

(22) Filed: Jan. 19, 2011

(30) Foreign Application Priority Data
Jan. 21, 2010 (JP) 2010-011258
Mar. 10, 2010 (JP) 2010-053249
Mar. 19, 2010 (JP) 2010-064383

(51) Int. Cl. C08F 2/46; B29C 65/14; B05D 3/00

(52) U.S. Cl. 427/487; 156/192; 427/372.2

(57) ABSTRACT

An aspect of the present invention provides a method of manufacturing a high-quality functional film having reduced defects such as cracks and cutouts in an inorganic film and having high producibility by transporting a supporting member with stability without causing degradation in performance when the inorganic film is grown on the supporting member. A lengthwise supporting member having a laminate film provided on its back surface side and having a self-supporting property is fed; a film of an inorganic material is formed on the front surface side of the supporting member while the supporting member is being transported under a vacuum; and the supporting member is wound into a film roll, thus manufacturing a functional film.

### BACKGROUND OF THE INVENTION

1. Field of the Invention

The present invention relates to a method of manufacturing a functional film.

2. Description of the Related Art

Various functional films, e.g., gas barrier films, protective films and optical films such as optical filters and antireflection films are used in various devices, e.g., display devices such as liquid crystal displays and organic EL displays, semiconductor devices and thin-film solar cells.

To manufacture functional films with efficiency and high productivity, roll-to-roll techniques for continuously forming a film on a lengthwise supporting member have been adopted.

To form a functional film, a substrate film is transported in a roll-to-roll manner and films are formed on the substrate film by a vacuum film forming method such as sputtering or plasma chemical vapor deposition (chemical CVD). For example, Japanese Patent Application Laid-Open Nos. 8-92727 and 2009-179853 disclose methods of manufacturing functional films (e.g., a barrier film) in which acrylate monomer or the like is applied, dried and set on a supporting member running continuously; the supporting member is thereafter wound into a roll; the roll of the supporting member on which the organic film is formed is fed into a vacuum film forming apparatus; and an inorganic film is formed on the organic film.

In a process of manufacturing a barrier film by laminating an inorganic material on an organic film, a defect in the organic film largely affects the resultant barrier performance. In particular, cutouts or flaws such as line defects or scratch defects in the organic film can be a cause of a considerable reduction in barrier performance.

Causes of the occurrence of such defects are roughly divided into two groups: one consisting of causes at the time of the application (causing defects at the time of application of the organic film) and the other consisting of causes that damage the film before forming of the inorganic film after the application.

With the former, the occurrence of a line defect is a major problem. The defect causes the organic layer functioning as a smooth layer to be lost. The organic film cannot be uniformly formed on such a defect.

With the latter, a scratch defect (a fault due to rubbing) may appear as an appearance defect, which causes a problem in use of the product. A fragment of the material of the supporting member scraped off the supporting member is attached to the scratch defect. The fragment may cause film forming failure in the inorganic film.

It can be said that the former problem can be solved by optimization of application conditions or some of other various techniques. However, evaluation with respect to the existence/nonexistence of line defects or the like is necessary in the manufacturing process.

Japanese Patent Application Laid-Open No. 2009-179853 discloses, as a solution to a problem such as the latter one in the above, roll-to-roll transport without contact with the surface of the organic film at the time of forming the inorganic film on the organic film. The technique disclosed in Japanese Patent Application Laid-Open No. 2009-179853 is useful because it enables transport without damage to the organic film.

### SUMMARY OF THE INVENTION

When a supporting member on which an inorganic film is formed is transported by a guide roller in a vacuum apparatus, the inorganic film contacts the guide roller, which affects the barrier performance of the inorganic film. In a vacuum apparatus in particular, the contact, i.e., friction, with a guide roller increases because no accompanying air exists in contrast with that in the atmosphere. The problem is that since the inorganic film is very thin, minuscule flaws occur in the inorganic film when the inorganic film contacts the guide roller, and the flaws impair the barrier performance.

If the supporting member used is thin and soft, the supporting member can easily bend in the widthwise direction to have longitudinal creases, depending on the tension necessary for transport. As a result, a place where the guide roller and the supporting member locally contact each other is subjected to a larger force, which causes the inorganic film to break easily. Also, when a fold occurs in the supporting member, the inorganic film itself can break easily.

Japanese Patent Application Laid-Open No. 2009-179853 discloses, as a solution to these problems, a method of transport in which only end portions of the supporting member are supported to maintain the film forming surface in a non-contact state. However, since the back surface of the film is not supported, longitudinal creases in the supporting member due to tension are increased if the supporting member is thin. Therefore, it is necessary to transport the supporting member at an extremely low speed or to increase the area of the supported portions for example, which largely reduces the productivity.

On the other hand, the productivity, cost and use concerns drive a strong need for reducing the layer thickness with respect to the kind and thickness of a supporting member. Also, a method of forming an inorganic film such as a barrier film has a step of exposing a supporting member to a heat source. This necessitates cooling of the supporting member from the side (back side) opposite from the film forming side. Cooling is performed by maintaining a cooling drum and the supporting member in close contact with each other. Therefore, control of the tension on the supporting member during transport is important.

In the case of performing roll-to-roll film forming in a vacuum film forming apparatus in particular, the temperature of a supporting member is ordinarily controlled from the back side by maintaining the supporting member in close contact with a drum, thereby controlling film forming. It is necessary to apply a tension to the supporting member in the longitudinal transport direction in order to achieve close contact with the drum. If the supporting member is thin and is not unyielding (has low rigidity), the supporting member is bent by the tension to cause a knick in the portion floating in a non-contact state. The knick in the supporting member acts as a cause of a folded crease or local contact, resulting in a flaw in an organic film.

In a process of making a barrier film, damage to a supporting member due to a solvent largely affects the barrier performance and other performances. For example, when a coating solution containing a solvent moves to the back surface of a supporting member in a roundabout manner in a step of forming an organic film, the coating solution cannot be easily dried. If the solvent resistance of the supporting member used is low, the solvent is absorbed in the supporting member to cause the supporting member to swell and deform. If the supporting member is permeated with the solvent for a long time and denatured, the supporting member opacifies, has an increased haze and loses transparency, resulting in a reduction in transmittance.

Further, in a case where a supporting member having solvent damage such as immersion/swell is set in a vacuum film forming process for forming an inorganic film, plasma emission in the film forming process becomes unstable due to the influence of outgasing from the supporting member. As a result, the formed inorganic film may have non-uniform film quality.

In a case where an inorganic film is formed by using the roll-to-roll technique in particular, the time taken for outgasing from a supporting member varies from the beginning to the end of film forming. The amount of outgasing is smaller at the first stage of film forming. However, the effect of outgasing accumulates toward the final stage of film forming. As a result, a product that is not uniform in the lengthwise direction is produced. Also, in a case where a thin supporting member is used, the solvent damage on the supporting member is considerably large. A deformation such as a curl occurs as well as a color change and degradation in performance. In some case, breakage of the supporting member can also occur.

In view of the above-described circumstances, an object of the present invention is to provide a method of manufacturing a high-quality functional film having reduced defects such as cracks and cutouts in an inorganic film and having high producibility, by transporting a supporting member with stability without causing any degradation in performance when the inorganic film is formed on the supporting member.

Another object of the present invention is to provide a functional film manufacturing method which, in a case where an organic film is prepared by applying a solvent or immersing a supporting member in a solvent, enables prevention of denaturation of the support member due to solvent damage and occurrence of outgasing in a vacuum film forming process performed after the preparation of the organic film.

Still another object of the present invention is to provide a functional film manufacturing method which when an inorganic film is formed on an organic film on a supporting member, enables prevention of degradation in performance and realizes evaluation of flaws or the like caused in the surface of the supporting member.

According to one aspect of the present invention, there is provided a method of manufacturing a functional film, including the steps of supplying a lengthwise supporting member having a laminate film provided on a back surface side of the supporting member and having a self-supporting property, forming a film of an inorganic material on a front surface side of the supporting member while transporting the supporting member under a vacuum, and winding the supporting member.

According to the above aspect, the supporting member having the laminate film on its back surface side has a self-supporting property. Therefore, even when the supporting member is transported under a vacuum while a tension is being applied to the supporting member, longitudinal creases or folds cannot be easily caused in the supporting member. Prevention of breakage of the inorganic film due to local contact leading to defects such as cutouts or cracks in the inorganic film is enabled. Prevention of occurrence of cracks in the inorganic film resulting from folds in the supporting member is enabled. As a result, a high-quality functional film can be obtained.

Preferably, the method of manufacturing a functional film according to the present invention includes the step of improving an adhesion between the supporting member and the laminate film before the step of forming the film of the inorganic material.

Preferably, in the method of manufacturing a functional film according to the present invention, the step of improving the adhesion includes at least one of the steps of heating the supporting member and the laminate film while applying a predetermined tension to the supporting member, and applying ultraviolet rays to the supporting member and the laminate film while applying a predetermined tension to the supporting member.

According to another aspect of the present invention, there is provided a method of manufacturing a functional film, including a first step of feeding a lengthwise supporting member having a laminate film having solvent resistance and provided on the back surface side of the supporting member, and applying a coating solution containing a solvent on the front surface side of the supporting member, and drying and setting the coating solution to form an organic film while transporting the supporting member, and a second step of forming an inorganic film on the organic film while transporting under a reduced pressure the supporting member on which the organic film is formed.

According to the above aspect, the laminate film adhered to the back surface of the supporting member has solvent resistance, thereby preventing degradation in quality resulting from solvent damage to the supporting member. Also, the generation of outgas from the supporting member during forming of the inorganic film is inhibited, thereby enabling forming of the inorganic film with improved quality.

Preferably, in the method of manufacturing a functional film according to the present invention, the solvent is at least one material selected from the group consisting of acetone, methyl ethyl ketone, methyl isobutyl ketone, cyclohexanone, ethanol, methanol, isopropanol, tetrahydrofuran, propylene glycol monomethylether acetate, toluene, xylene and dichloroethane, and the laminate film has resistance to the solvent selected from the above group.

The coating solution for forming the organic film has a large content of some of the solvents shown above. It is, therefore, preferable that the laminate film have resistance to these solvents.

Preferably, in the method of manufacturing a functional film according to the present invention, the laminate film is constituted by one of polypropylene, polyethylene, polyethylene terephthalate, or a combination of these materials.

Preferably, in the method of manufacturing a functional film according to the present invention, the amount of outgas from the supporting member in the second step of forming the inorganic film on the organic film is 1% or less of the amount of gas introduced to form the inorganic film.

According to still another aspect of the present invention, there is provided a method of manufacturing a functional film, including a first step of feeding a lengthwise supporting member having a black laminate film provided on a back surface side of the supporting member and having self-supporting property, and forming an organic film on a front surface side of the supporting member while transporting the supporting member, a second step of forming an inorganic film on the organic film while transporting the supporting member under a condition at a reduced pressure, and a third step of inspecting a surface of the supporting member in the state of having the black laminate film provided.

According to the above aspect, the supporting member has the laminate film on its back surface side and, therefore, has a self-supporting property, such that longitudinal creases or folds cannot be easily caused even when the supporting member is transported while a tension is applied to the supporting member. Thus, prevention of occurrence of defects such as cutouts or cracks in the organic film or the inorganic film resulting from longitudinal creases or folds is enabled. Further, prevention of local contact between the supporting member and a guide roller due to longitudinal creases or folds is enabled. As a result, a high-quality functional film having reduced defects can be obtained.

Since the laminate film is black in color, flaws or the like caused in the surface of the supporting member can be easily inspected while the supporting member is being transported. The surface of the supporting member means the surface of the supporting member in a state before film forming, means the surface of the organic film on the supporting member in the state where the organic film is formed, and means the surface of the inorganic film on the supporting member in the state where the inorganic film is formed.

Preferably, in the method of manufacturing a functional film according to the present invention, the black laminate film is a PET film.

Preferably, in the method of manufacturing a functional film according to the present invention, the total thickness of the laminate film and the supporting member is 75 μm or more.

Preferably, in the method of manufacturing a functional film according to the present invention, the thickness of the film of the inorganic material formed in the step of forming the film of the inorganic material is equal to or larger than 5 nm and equal to or smaller than 200 nm.

Preferably, in the method of manufacturing a functional film according to the present invention, the inorganic material in the above invention includes at least one of a metal, a metal oxide, a metal nitride, a metal carbide, a metal fluoride and a composite material formed of some of these materials.

Preferably, in the method of manufacturing a functional film according to the present invention, the organic film includes one of a radiation-curing monomer and a radiation-curing oligomer.

According to the present invention, a high-quality functional film having reduced defects such as cracks and cutouts in the inorganic film and having high producibility can be obtained.

According to the present invention, degradation in quality of the supporting member resulting from solvent damage can be prevented and the generation of outgas from the supporting member during forming of the inorganic film can be inhibited, thereby enabling manufacture of a high-quality functional film.

According to the present invention, evaluation of flaws or the like caused in the surface of the supporting member can be realized without degrading the performance when the inorganic film is formed on the organic film on the supporting member.

### BRIEF DESCRIPTION OF THE DRAWINGS

FIG. 1 is a diagram showing the construction of a functional film;

FIGS. 2A and 2B are diagrams showing examples of apparatuses for carrying out a method of manufacturing a functional film;

FIGS. 3A and 3B are diagrams showing examples of apparatuses for carrying out a method of manufacturing a functional film;

FIGS. 4A and 4B are diagrams schematically showing states of transport with a stepped roller;

FIG. 5 is a table showing the results of an example in a first embodiment of the present invention;

FIG. 6 is a table showing the results of an example in a second embodiment of the present invention; and

FIG. 7 is a table showing the results of an example in a third embodiment of the present invention.

### DETAILED DESCRIPTION OF THE PREFERRED EMBODIMENTS

Preferred embodiments of the present invention will be described with reference to the accompanying drawings. The present invention will be described with respect to the following preferred embodiments. However, changes can be made in the embodiments by a number of techniques without departing from the scope of the present invention and embodiments other than the described embodiments can be used. Accordingly, all changes within the scope of the present invention are included in the claims. Also, a numeric value range expressed by using “(a numeric value) to (a numeric value)” means the range including the numeric value before “to” and the numeric value after “to”.

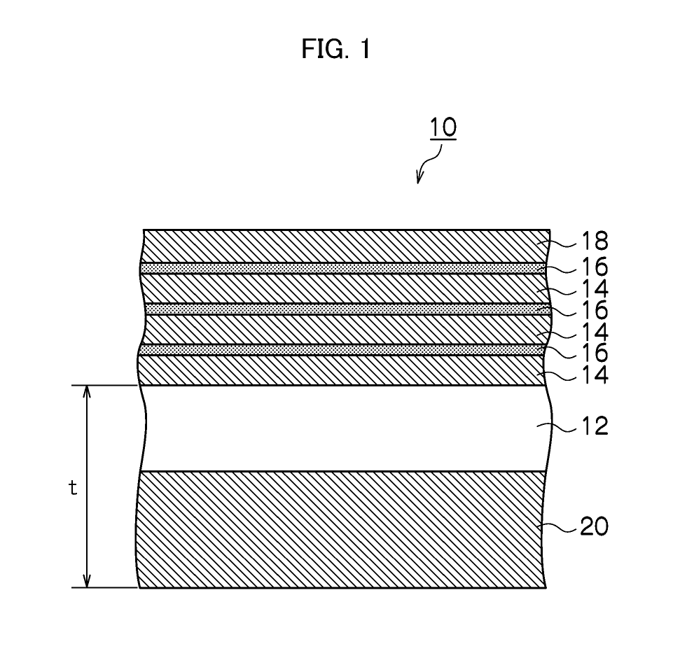

FIG. 1 is a diagram showing the construction of a functional film having a laminate film in its back surface. As shown in FIG. 1, the functional film 10 includes an organic film 14 formed on a surface of a supporting member 12, and an inorganic film 16 formed on the organic film 14. The functional film 10 shown in FIG. 1 includes three identical groups of films provided one on another and each consisting of a unit dual-layer combination of organic film 14 and inorganic film 16. The functional film 10 has the organic film 18 in an outermost layer. The structure of the organic film 14 and the inorganic film 16 formed on the front surface side of the supporting member 12 is not limited to that described above. The organic film 14 and the inorganic film 16 can be formed in this order on the front surface side of the supporting member 12. A laminate film is adhered to the back surface of the supporting member 12.

### First Embodiment

A functional film in a first embodiment has the layer structure shown in FIG. 1. A laminate film 20 is adhered to impart a self-supporting property to the composite member consisting of the supporting member 12 and the laminate film 20. It is preferable that the total thickness t of the supporting member 12 and the laminate film 20 be 75 μm or more. If the total thickness t is 75 μm or more, the desired self-supporting property of the composite member consisting of the supporting member 12 and the laminate film 20 can be secured.

The self-supporting property of a film is the unyieldingness (rigidity) of the film. The magnitude of the self-supporting property is defined as the product of the Young's modulus (GPa) and the cube of the film thickness (w). In the case of the composite member formed by adhering the laminate film to the supporting member, the self-supporting property is defined as the product of the average of the Young's modulus (GPa) of the supporting member and the Young's modulus (GPa) of the laminate film and the cube of the total thickness (μm) of the composite member. The necessary range of the self-supporting property in the present embodiment is 2(GPa)×100(μm)³ to 6(GPa)×200(μm)³.

The supporting member 12 is not particularly specified if forming of the organic film 14 and forming of the inorganic film 16 in a vacuum film forming manner can be performed thereon. Any of various supporting members used in functional films, e.g., various resin films including PET film and various metal sheets including an aluminum sheet can be used.

As the laminate film 20, any of polyethylene (PE), polyethylene terephthalate (PET), polyethylene naphthalate (PEN), polycarbonate (PC), cyclo-olefin polymer (COP) and the like can be used as the laminate film 20 if it is capable of imparting the desired self-supporting property to the supporting member 12. The laminate film 20 may be provided on the back surface of the supporting member 12 when the inorganic film 16 is formed by vacuum film forming. If the laminate film 20 is separated from the supporting member 12, it is preferable that the force of adhesion between the supporting member 12 and the laminate film 20 be set smaller than the force of adhesion between the supporting member 12 and the organic film 14 or the inorganic film 16 formed on the front surface side of the supporting member 12.

The organic film 14 includes all films formed before forming of the inorganic film, e.g., an anchor coat layer for improving the adhesion, an oxide film formed by atmospheric-pressure plasma and a thermosetting or ultraviolet-curing organic film.

It is preferable that the inorganic film 16 include at least one of a metal, a metal oxide, a metal nitride, a metal carbide, a metal fluoride, and a composite material containing some of these materials.

The functional film 10 having a predetermined function can be obtained by forming the inorganic film 16 or the laminate of the inorganic film 16 and the organic film 14 on the front surface side of the supporting member 12.

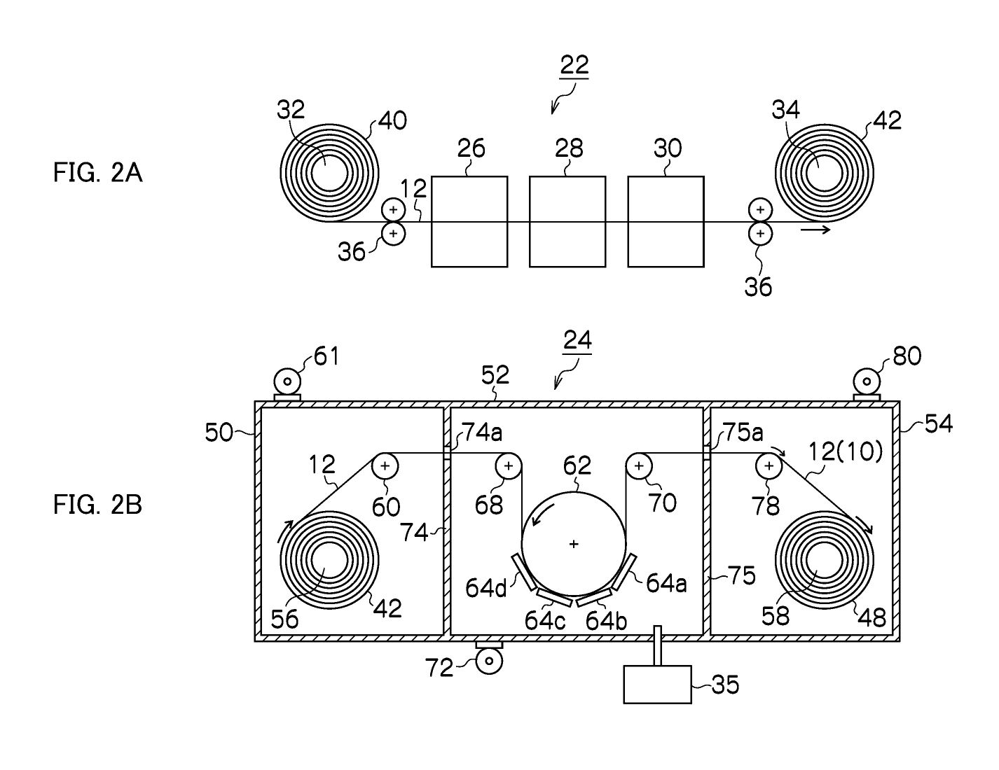

A method and apparatus for manufacturing the functional film in the first embodiment will be described with reference to FIGS. 2A and 2B. The manufacturing apparatus for manufacturing the functional film is constituted by, for example, an organic film forming apparatus 22 for forming the organic film on the front surface of the supporting member 12 and a vacuum film forming apparatus 24 for forming the inorganic film on the organic film.

FIG. 2A schematically shows an example of the organic film forming apparatus 22. The organic film forming apparatus 22 has an application device 26, a heating device 28, and an ultraviolet (UV) irradiation device 30. This organic film forming apparatus 22 forms the organic film in a roll-to-roll manner. First, a film roll 40 is loaded in a feeder 32. Subsequently, the supporting member 12 is transported from the film roll 40 in the lengthwise direction by take-in rollers 36. A coating solution containing, for example, a radiation-curing monomer or oligomer prepared in advance is applied to the supporting member 12 by the application device 26. The coating solution is dried by the heating device 28, with the solvent evaporated. The coating solution after drying is irradiated with ultraviolet rays by the UV irradiation device 30 to initiate polymerization reaction. The organic film is hardened and formed on the supporting member 12. Finally, the supporting member 12 on which the organic film is formed is wound as a film roll 42 by a winder 34. At this time, a winding tension to the supporting member 12 is controlled.

In the present embodiment, the supporting member 12 having the laminate film provided on its back surface and having a self-supporting property is wound into a roll and prepared as the film roll 40. With the laminate film, the self-supporting property is imparted to the supporting member 12. During transport from the feeder 32 to the winder 34, therefore, any longitudinal creases, folds or the like are not caused in the supporting member 12. Prevention of breakage of the organic film formed on the supporting member 12 is thus enabled. In particular, through prevention of breakage of the organic film before forming of the inorganic film, prevention of occurrence of a film forming failure region (i.e., a defect) in the inorganic film is enabled.

As shown in FIG. 2B, the vacuum film forming apparatus 24 is an apparatus for performing film forming in a roll-to-roll manner, as is the organic film forming apparatus 22. The supporting member 12 is fed from the film roll 42 by a feeder 56. The inorganic film is formed on the organic film on the supporting member 12 while the supporting member 12 is being transported in the lengthwise direction. The supporting member 12 on which the laminate formed of the organic film and the inorganic film is formed is wound into a film roll 48 by a winder 58. The vacuum film forming apparatus 24 is provided with a supply chamber 50, a film forming chamber 52 and a winding chamber 54.

The film roll 42 in which the supporting member 12 on which the organic film is formed is wound is loaded in the supply chamber 50 of the vacuum film forming apparatus 24. The supply chamber 50 is provided with the feeder 56, a guide roller 60 and a vacuum pumping device 61. The film roll 42 in which the supporting member 12 on which the organic film is formed is loaded in the feeder 56 in the supply chamber 50. The supporting member 12 is fed from the film roll 42 and is transported from the supply chamber 50 into the film forming chamber 52 through a slit 74a in a partition wall 74. In the supply chamber 50, the feeder 56 is rotated clockwise as viewed in the figure by a drive source (not shown). The supporting member 12 is transported from the film roll 42 into the film forming chamber 52 through a predetermined path by the guide roller 60. The supporting member 12 has the organic film on its front surface side and the laminate film adhered to its back surface side. The supporting member 12 has the self-supporting property imparted with the laminate film.

The vacuum pumping device 61 is disposed on the supply chamber 50. The interior of the supply chamber 50 is decompressed to a predetermined pressure according to a film forming pressure in the film forming chamber 52 by the vacuum pumping device 61, thereby preventing the pressure in the supply chamber 50 from badly influencing the pressure (film forming) in the film forming chamber 52. A well-known vacuum pumping device can be used as the vacuum pumping device 61 and also as a vacuum pumping device 72 on the film forming chamber 52.

The supporting member 12 is guided by the guide roller 60 to be transported into the film forming chamber 52. In the film forming chamber 52, the inorganic film is formed on the surface of the supporting member 12, i.e., on the surface of the organic film. As shown in FIG. 2B, the film forming chamber 52 is provided with a drum 62, film forming devices 64a, 64b, 64c, and 64d, guide rollers 68 and 70, the vacuum pumping device 72 and a gas supply device 35. If in the film forming chamber 52 film forming is performed by sputtering, plasma CVD or the like, a radiofrequency power supply or the like is further provided on the film forming chamber 52.

The drum 62 in the film forming chamber 52 is rotated counterclockwise on a center axis as viewed in the figure by a drive source (not shown). The supporting member 12 is guided into a predetermined path by the guide roller 68. The supporting member 12 is wrapped in a predetermined region around the peripheral surface of the drum 62 and is transported through the predetermined transport path while being supported and guided by the drum 62. The inorganic film is formed on the organic film by the film forming devices 64a to 64d. It is preferable that the inorganic film formed at this time have a thickness of 5 nm to 200 nm.

The film forming devices 64a to 64d are devices for forming the inorganic film on the surface of the supporting member 12 by a vacuum film forming method. The film forming devices are not particularly specified. Any of well-known vacuum film forming methods (vapor phase deposition methods) such as CVD, plasma CVD, sputtering, vacuum deposition and ion plating can be used.

Accordingly, the film forming devices 64a to 64d are constituted by various members according to the vacuum deposition method to be carried out. For example, if in the film forming chamber 52 forming of the inorganic film is performed by induction-coupled plasma CVD (ICP-CVD), the film forming devices 64a to 64d include an induction coil for forming an induction magnetic field and a gas supply device for supplying reactive gas to the film forming region.

If in the film forming chamber 52 forming of the inorganic film is performed by capacitively-coupled plasma CVD (CCP-CVD), the film forming devices 64a to 64d include a shower electrode which is of a hollow type, has a multiplicity of small holes in the surface facing the drum 62, is connected to a reactive gas supply source, and functions as a radiofrequency electrode and a reactive gas supply device.

If in the film forming chamber 52 forming of the inorganic film is performed by vapor phase film forming, in this case CVD, the film forming devices 64a to 64d include a reactive gas introduction device.

If in the film forming chamber 52 forming of the inorganic film is performed by sputtering, the film forming devices 64a to 64d include a target holding device, a radiofrequency electrode and a sputtering gas supply device.

The vacuum pumping device 72 evacuates the film forming chamber 52 to a degree of vacuum according to forming of the inorganic film by the vacuum film forming method. The vacuum pumping device 72 is not particularly specified. As the vacuum pumping device 72, any of well-known (vacuum) pumping devices used in vacuum film forming apparatuses and using devices including a vacuum pump such as a turbo pump, a mechanical booster pump or a rotary pump, an auxiliary device such as a cryocoil and devices for adjusting the degree of vacuum reached and the amount of evacuation can be used.

The supporting member 12 having the inorganic film formed thereon is guided into a slit 75a in a partition wall 75 by guide rollers 70 and 78 to be transported into the winding chamber 54. On the winding chamber 54, a vacuum pumping device 80 is provided. The interior of the winding chamber 54 is evacuated to a predetermined pressure by the vacuum pumping device 80. The supporting member 12 is wound into the film roll 48 by the winder 58 provided in the winding chamber 54.

In the supply chamber 50, transport devices for transporting the supporting member 12 through the predetermined path, e.g., a pair of transport rollers and a guide member for regulating the position of the supporting member 12 in the widthwise direction may be provided in addition to those illustrated in the figure.

The laminate film is provided on the back surface of the supporting member 12 to impart suitable rigidity to the supporting member 12, on which the inorganic film is formed. The supporting member 12 can be transported through the vacuum film forming apparatus 24 (or moved forward and backward a certain number of times) without causing any longitudinal creases or folds. Thus, prevention of occurrence of defects in the inorganic film due to film forming failures is enabled and the inorganic film can be obtained with improved quality.

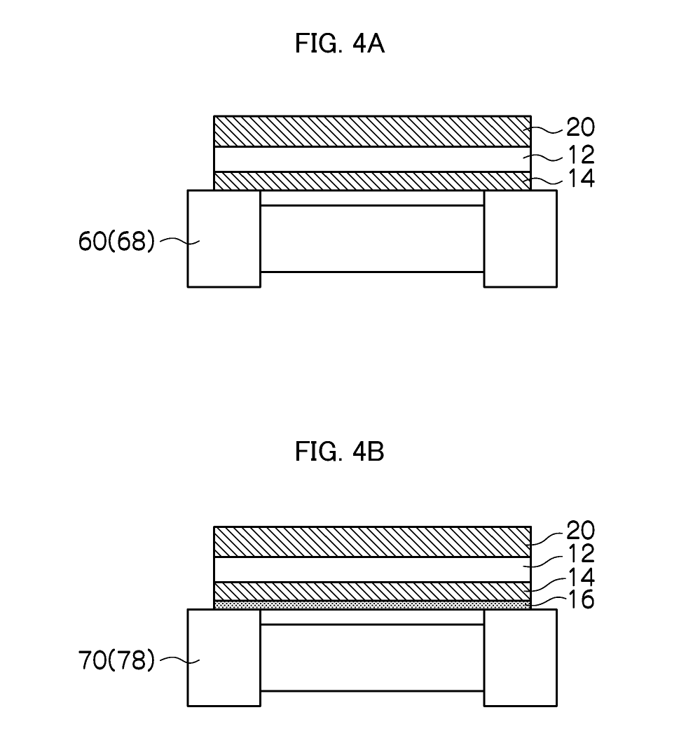

FIGS. 4A and 4B show states of transport of the supporting member in the vacuum film forming apparatus. In the vacuum film forming apparatus, it is preferable to transport the supporting member 12 with stepped guide rollers such that the guide rollers contact only end portions of the supporting member 12 (end portions in a direction (width direction) perpendicular to the direction of transport). In ordinary cases, functional films including various films on supporting members 12 are not used entirely through their lengths as products. Portions in the vicinities of the ends are cut off. Even if such a portion is used, it is not necessary that it should function as a functional film. That is, with end portions of functional films deteriorated in performance or characteristics, there is no problem in terms of use as a product.

FIG. 4A shows the state of the supporting member 12 during transport before forming of the inorganic film. In each of the stepped guide rollers 60 and 68, two end portions are larger in diameter than a central portion. The organic film 14 contacts only the two end portions of the guide rollers 60 and 68. The region of the organic film 14 actually used as a product (actually functioning portion) does not contact the guide rollers 60 and 68. In particular, since the laminate film 20 is adhered to the back surface of the supporting member 12, longitudinal creases or folds cannot be easily caused in the supporting member 12 even when a tension is applied to the supporting member 12. The actually functioning portion of the organic film 14 has improved surface smoothness and surface characteristics without being deteriorated in performance and characteristics. Therefore, the performance of the inorganic film 16 formed on the organic film 14 is not impaired.

FIG. 4B shows the state of the supporting member 12 during transport after forming of the inorganic film. In each of the stepped guide rollers 70 and 78, two end portions are larger in diameter than a central portion. The inorganic film 16 contacts only the two end portions of the guide rollers 70 and 78. The actually functioning portion of the inorganic film 16 does not contact the guide rollers 70 and 78. Since the laminate film 20 is adhered to the back surface of the supporting member 12, longitudinal creases or folds cannot be easily caused in the supporting member 12. Therefore, the actually functioning portion of the inorganic film 16 has no reductions in performance and characteristics due to cutouts or the like.

Since the self-supporting property is imparted to the supporting member with the laminate film, the speed of transport of the supporting member can be increased even when the supporting member is supported only by the end portions of the stepped guide rollers. Also, the stability of transport can be remarkably improved.

In ordinary cases of using stepped guide rollers, the tension for transport cannot be increased because of the existence of the steps. In particular, if the supporting member does not have a sufficiently high self-supporting property, it can bend easily at its central portion and, therefore, the upper limit value of the tension is reduced. On the other hand, increasing the transport speed requires increasing the tension, which is necessary for elimination of slippage as well. It is possible to prevent bending even under a certain tension by improving the self-supporting property with the laminate film formed on the back surface side, and to thereby enable increasing the speed of transport of the supporting member. With the higher self-supporting property, the amount of deformation at the stepped portions is reduced, meandering and variation in tension are eliminated and the stability (accuracy) of transport is improved.

Next, as shown in FIG. 2B, the film roll 48 is set as the film roll 40 in the feeder 32 in the organic film forming apparatus 22 and the organic film is formed on the inorganic film. The supporting member 12 on which the organic film, inorganic film and organic film are formed is wound as the film roll 42 by the winder 34.

Next, the film roll 42 is loaded in the supply chamber 50 in the vacuum film forming apparatus 24. The inorganic film is formed on the supporting member 12. By the organic film forming step and the inorganic film forming step repeated a certain number of times, the desired functional film is manufactured.

Forming the film of the organic material and forming the film of the inorganic material are repeated three times and a film of the organic material is formed in the outermost layer, thus manufacturing the functional film shown in FIG. 1.

After the completion of forming of the predetermined organic film and inorganic film on the supporting member, the laminate film can be separated from the supporting member. This is because the laminate film is adhered to the back surface of the supporting member not for the purpose of protecting the supporting member but for the purpose of securing the desired self-supporting property during the film forming process.

The laminate film is adhered to impart the self-supporting property to the supporting member in contrast with the mode in which the supporting member itself is increased in thickness to have the self-supporting property. Therefore, the laminate film can be separated at the time of product processing after making of the functional film, and the self-supporting property can be adjusted through the thickness of the laminate. Since the supporting member is not increased in thickness in the case of imparting the self-supporting property by adhering the laminate film, the functional film can be manufactured at a lower cost in comparison with the case where the supporting member itself, provided at a high unit price, is increased in thickness. In a case where there is a need to reduce the thickness of the supporting member, the product can be manufactured without reducing the production efficiency since the desired self-supporting property is imparted by adhering the laminate film.

In particular, the influence of attachment of a foreign material to the smooth surface on the supporting member before forming of the inorganic film is considerable with respect to a failure in forming of the inorganic film, which may occur thereafter. The smooth surface on the supporting member means the surface of the supporting member in the case where the inorganic film is formed directly on the supporting member, and means the surface of the organic film in the case where the organic film is formed on the supporting member. There is a need for improving the transport accuracy with respect to how the supporting member before forming of the inorganic film is protected. For improvement in the transport accuracy, not only adhering the laminate film from the viewpoint of protection but also paying attention to the self-supporting property (rigidity) is required and the total thickness as the sum of the thickness of the supporting member on which the inorganic film is formed and the thickness of the laminate film is also important.

It is preferable to process the supporting member and the laminate film through a step for improving the force of adhesion between the supporting member and the laminate film before forming of the inorganic film. It is preferable to perform processing through a heating zone and/or an ultraviolet curing zone as a step for improving the force of adhesion. The supporting member with the laminate film may be passed through a heating zone and/or an ultraviolet curing zone provided before the vacuum film forming apparatus. Alternatively, the heating device 28 and the UV irradiation device 30 in the organic film forming apparatus 22 shown in FIG. 2A may be used as an adhesion-force-improving step. When this step is performed, the supporting member with the laminate film is wound by the winder 34 while a certain tension (about 50 to 500 N/m) is applied by the transport devices. The supporting member and the laminate film wound while receiving heat have improved adhesion therebetween as a result of pressure contact with the take-in rollers 36 such as to be not easily separable or deformable when handled during vacuum film forming.

As the material of the organic film, a material may suffice which enables, for example, use of an anchor coat layer for improving the adhesion, an oxide film formed by atmospheric-pressure plasma and a thermosetting or ultraviolet-curing organic film before forming of the inorganic film.

More specifically, for example, it is preferable to use a monomer or an oligomer having two or more ethylenic unsaturated double bonds and addition-polymerizable when irradiated with light.

For example, the strength and the surface smoothness can be improved by applying an ultraviolet-curing resin as the organic film. As an example of the ultraviolet-curing resin, a mixed solution containing a mixture of 15 g of BEPGA, a polymerizable monomer product from Kyoeisha Chemical Co., Ltd., and 5 g of polymerizable monomer V-3PA, a product from Osaka Organic Chemical Industry Ltd., 1.5 g of ultraviolet polymerization initiator (a product from Lamberti, product name: Esacure KTO-46) and 190 g of 2-butanone may be applied to the supporting member to form the organic film.

In place of BEPGA and V-3PA, acrylic monomers: KAYARAD DPHA (a product from Nippon Kayaku Co., Ltd.) and KAYARAD TMPTA (a product from Nippon Kayaku Co., Ltd.) may be used.

For example, the adhesion can be improved by applying a thermosetting resin as the organic film. As an example of the thermosetting resin, a thermosetting resin (epoxy resin EPICLON 840-S (bisphenol-A liquid form), a product from DIC Corporation) may be diluted with methyl ethyl ketone, adjusted so that the solid content concentration is 5% and thereafter applied to the supporting member to form the organic film. As another example, a polyester resin (VYLON 200, a product from Toyobo Co., Ltd.) may be used.

As a method of forming the organic film, an ordinary solution application method, a vacuum film forming method or the like may be mentioned. Application can be performed by a solution application method, e.g., dip coating, air-knife coating, curtain coating, roller coating, wire-bar coating, gravure coating, slide coating or extrusion coating using a hopper described in the specification of U.S. Pat. No. 2,681,294.

For example, in a case where a gas barrier film (water vapor barrier film) is manufactured as a functional film, it is preferable to form silicon nitride film, aluminum oxide film, silicon oxide film or the like as the inorganic film.

In a case where a protective film for various devices or apparatuses, such as display devices including organic EL displays and liquid crystal displays, is manufactured as a functional film, it is preferable to form silicon oxide film or the like as the inorganic film.

Further, in a case where a functional film such as an antireflection film, a light reflective film or any of various filters is manufactured, it is preferable to form a film having or capable of developing the desired optical characteristics as the inorganic film.

While the method of manufacturing a functional film according to the present invention has been described in detail, the present invention is not limited to the above-described embodiment. Various changes and modifications may be made in the described embodiment without departing from the gist of the present invention.

### Second Embodiment

A functional film in a second embodiment has the layer structure shown in FIG. 1. The organic film 14 is formed by supplying a coating solution containing a solvent to the supporting member 12 and drying and setting the solution. The back surface of the supporting member 12 can be protected from the solvent by adhering a laminate film 20 having solvent resistance, thereby preventing swelling and deformation of the supporting member caused by the solvent. Further, even in a case where the supporting member is set under a reduced pressure for forming the inorganic film, the occurrence of outgasing resulting from swelling of the supporting member can be inhibited.

The supporting member 12 is not particularly specified if forming of the organic film 14 and forming of the inorganic film 16 by vacuum film forming can be performed thereon. Any of various supporting members used for functional films, e.g., any of various resin film including PET film or any of metal sheets including an aluminum sheet can be used.

If the laminate film 20 is separated from the supporting member 12, it is preferable that the force of adhesion between the supporting member 12 and the laminate film 20 be set smaller than the force of adhesion between the supporting member 12 and the organic film 14 or the inorganic film 16 formed on the front surface side of the supporting member 12.

The organic film 14 includes all films formed before forming of the inorganic film, e.g., an anchor coat layer for improving the adhesion, an oxide film formed by atmospheric-pressure plasma and a thermosetting or ultraviolet-curing organic film.

It is preferable that the inorganic film 16 include at least one of a metal, a metal oxide, a metal nitride, a metal carbide, a metal fluoride and a composite material containing some of these materials.

The functional film 10 having a predetermined function can be obtained by forming the inorganic film 16 or the laminate of the inorganic film 16 and the organic film 14 on the front surface side of the supporting member 12.

A method and apparatus for manufacturing the functional film in the second embodiment will be described with reference to FIGS. 2A and 2B. The manufacturing apparatus for manufacturing the functional film is constituted by, for example, the organic film forming apparatus 22 for forming the organic film on the front surface of the supporting member 12 and the vacuum film forming apparatus 24 for forming the inorganic film on the organic film. The same components as those in the first embodiment are indicated by the same reference characters, and some of the descriptions for them are omitted.

When the coating solution is applied to the supporting member 12 by the application device 26 as shown in FIG. 2A, the coating solution may move to the back surface of the supporting member 12 in a roundabout manner. In the present embodiment, the laminate film having solvent resistance is adhered to the back surface of the supporting member 12. Therefore, the coating solution does not directly contact the supporting member 12. The laminate film prevents the supporting member 12 from being damaged by the solvent.

It is necessary to adhere the laminate film before application of the coating solution. A first possible method is such that the film roll 40 with the laminate film is prepared. A second possible method is such that the laminate film is adhered to the back surface of the supporting member 12 while the supporting member 12 is being fed from the film roll 40 by the feeder 32.

Examples of the solvent used in the coating solution are acetone, methyl ethyl ketone (MEK), methyl isobutyl ketone (MIBK), cyclohexanone, ethanol, methanol, isopropanol (IPA), tetrahydrofuran (THF), propylene glycol monomethylether acetate (PGMEA), toluene, xylene and dichloroethane. In industry, MEK easily diffusible/scatterable when applied to the supporting member (having low surface tension and low viscosity) is ordinarily used.

As the laminate film on the back surface, a film formed of polypropylene, polyethylene, polyethylene terephthalate or a combination of these materials having resistance to the above-described solvent is used.

As shown in FIG. 2B, the supporting member 12 is fed from the film roll 42 and transported from the supply chamber 50 into the film forming chamber 52 through the slit 74a in the partition wall 74. In the supply chamber 50, the feeder 56 is rotated clockwise as viewed in the figure by a drive source (not shown). The supporting member 12 is transported from the film roll 42 into the film forming chamber 52 through a predetermined path by the guide roller 60. The supporting member 12 has the organic film on its front surface side and the laminate film having solvent resistance adhered to its back surface.

When the inorganic film is formed, the laminate film adhered to the back surface of the supporting member 12 exists. The back surface of the supporting member 12 does not directly contact the solvent and is not denatured by swelling or the like. Therefore, outgasing from the supporting member 12 is inhibited and the organic film can be formed with high quality in the lengthwise direction of the supporting member 12. The rate of outgasing from the supporting member 12 at this time is reduced to 1% or less of the flow rate of the reactive gas supplied from the gas supply device 35.

FIG. 4A shows the state of the supporting member 12 during transport before forming of the inorganic film. The supporting member 12 has the laminate film 20 having solvent resistance adhered to its back surface. In each of the stepped guide rollers 60 and 68, two end portions are larger in diameter than a central portion. The organic film 14 contacts only the two end portions of the guide rollers 60 and 68. The region of the organic film 14 actually used as a product (actually functioning portion) does not contact the guide rollers 60 and 68.

FIG. 4B shows the state of the supporting member 12 during transport after forming of the inorganic film. In each of the stepped guide rollers 70 and 78, two end portions are larger in diameter than a central portion. The inorganic film 16 contacts only the two end portions of the guide rollers 70 and 78. The actually functioning portion of the inorganic film 16 does not contact the guide rollers 70 and 78.

A self-supporting property can be imparted to the supporting member 12 by suitably selecting the thickness and material of the laminate film 20. The self-supporting property can be improved by means of the laminate film 20 to prevent the supporting member 12 from being bent even under tension. The speed of transport of the supporting member 12 can be increased in this way. With the higher self-supporting property, the amount of deformation at the stepped portions is reduced and meandering and variation in tension are eliminated, thus enabling improving the stability (accuracy) of transport.

Next, as shown in FIG. 2B, the film roll 48 is set as the film roll 40 in the feeder 32 in the organic film forming apparatus 22 and the organic film is formed on the inorganic film. The supporting member 12 on which the organic film, inorganic film and organic film are formed is wound as the film roll 42 by the winder 34.

Next, the film roll 42 is loaded in the supply chamber 50 in the vacuum film forming apparatus 24. The inorganic film is formed on the supporting member 12. By the organic film forming step and the inorganic film forming step repeated a certain number of times, the desired functional film is manufactured.

Forming the film of the organic material and forming the film of the inorganic material are repeated three times and a film of the organic material is formed in the outermost layer, thus manufacturing the functional film shown in FIG. 1.

After the completion of forming of the predetermined organic film and inorganic film on the supporting member, the laminate film can be separated from the supporting member. The laminate film is adhered to the back surface of the supporting member for the purpose of protecting the back surface of the supporting member from the solvent. Therefore the laminate film can be separated after the completion of the film forming process.

It is preferable to process the supporting member and the laminate film through a step for improving the force of adhesion between the supporting member and the laminate film before forming of the inorganic film. It is preferable to perform processing through a heating zone and/or an ultraviolet curing zone as a step for improving the force of adhesion. The supporting member with the laminate film may be passed through a heating zone and/or an ultraviolet curing zone provided before the vacuum film forming apparatus. Alternatively, the heating device 28 and the UV irradiation device 30 in the organic film forming apparatus 22 shown in FIG. 2A may be used as an adhesion-force-improving step. When this step is performed, the supporting member with the laminate film is wound by the winder 34 while a certain tension (about 50 to 500 N/m) is applied by the transport devices. The supporting member and the laminate film wound while receiving heat have improved adhesion therebetween as a result of pressure contact with the take-in rollers 36 such as to be not easily separable or deformable when handled during vacuum film forming.

The same material for the organic film as that in the first embodiment can be used. The same method of forming the organic film as that in the first embodiment can be used. As the inorganic film, a suitable film can be selected according to the purpose with which the functional film is provided, as in the first embodiment.

### Third Embodiment

A functional film in a third embodiment has the layer structure shown in FIG. 1. A black laminate film 20 is adhered to the back surface side of the supporting member 12. By adhering the laminate film 20, a self-supporting property is imparted to the composite member consisting of the supporting member 12 and the laminate film 20. It is preferable that the total thickness t of the supporting member 12 and the laminate film 20 be 75 μm or more. If the total thickness t is 75 μm or more, the desired self-supporting property of the composite member consisting of the supporting member 12 and the laminate film 20 can be secured.

The self-supporting property of a film is the unyieldingness (rigidity) of the film. The magnitude of the self-supporting property is defined as the product of the Young's modulus (GPa) and the cube of the film thickness (w). In the case of the composite member formed by adhering the laminate film to the supporting member, the self-supporting property is defined as the product of the average of the Young's modulus (GPa) of the supporting member and the Young's modulus (GPa) of the laminate film and the cube of the total thickness (μm) of the composite member. The necessary range of the self-supporting property in the present embodiment is 2(GPa)×100(μm)³ to 6(GPa)×200(μm)³.

Since the laminate film 20 is black in color, it is capable of eliminating reflection and therefore enables easy detection of a flaw or the like in the surface of the supporting member 12.

The supporting member 12 is not particularly specified if forming of the organic film 14 and forming of the inorganic film 16 in a vacuum film forming manner can be performed thereon. Any of various supporting members used in functional films, e.g., various resin films including a PET film and various metal sheets including an aluminum sheet can be used.

As the laminate film 20, any of PE, PET, PEN, PC, COP and the like can be used if it is capable of imparting a self-supporting property to the supporting member 12 and capable of being colored in black. The laminate film 20 may be provided on the back surface of the supporting member 12 when the inorganic film 16 is formed by vacuum film forming. If the laminate film 20 is separated from the supporting member 12, it is preferable that the force of adhesion between the supporting member 12 and the laminate film 20 be set smaller than the force of adhesion between the supporting member 12 and the organic film 14 or the inorganic film 16 formed on the front surface side of the supporting member 12.

The organic film 14 includes all films formed before forming of the inorganic film, e.g., an anchor coat layer for improving the adhesion, an oxide film formed by atmospheric-pressure plasma and a thermosetting or ultraviolet-curing organic film.

It is preferable that the inorganic film 16 include at least one of a metal, a metal oxide, a metal nitride, a metal carbide, a metal fluoride and a composite material containing some of these materials.

The functional film 10 having a predetermined function can be obtained by forming the inorganic film 16 or the laminate of the inorganic film 16 and the organic film 14 on the front surface side of the supporting member 12.

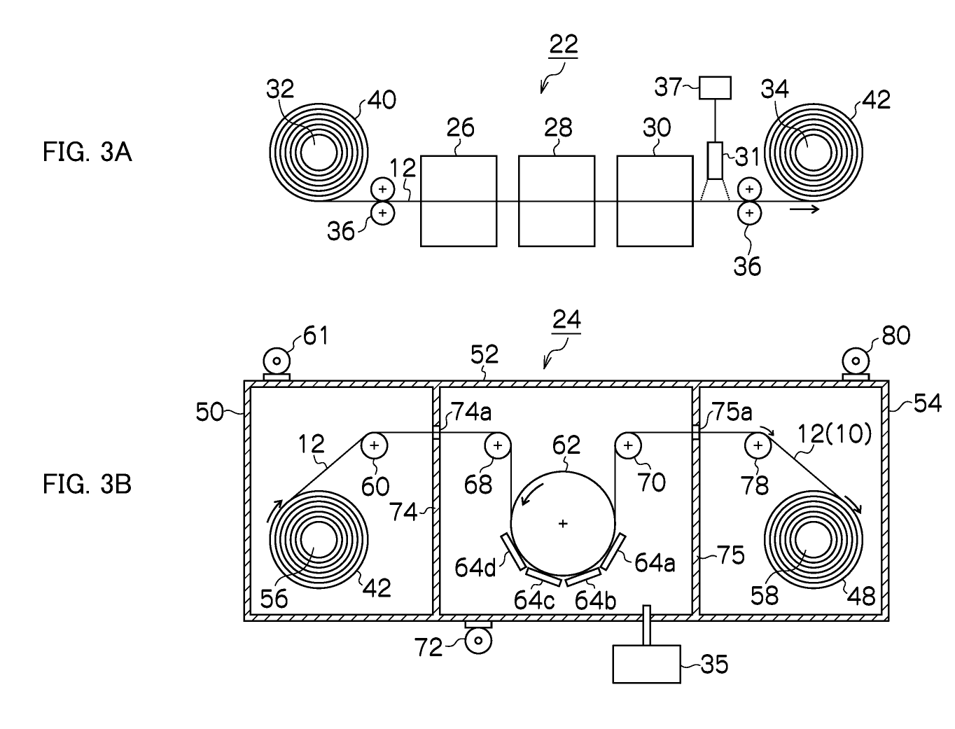

A method and apparatus for manufacturing the functional film in the third embodiment will be described with reference to FIGS. 3A and 3B. For example, the manufacturing apparatus for manufacturing the functional film is constituted by the organic film forming apparatus 22 for forming the organic film on the front surface of the supporting member 12 and the vacuum film forming apparatus 24 for forming the inorganic film on the organic film. The same components as those in the first embodiment and the second embodiment are indicated by the same reference characters, and some of the descriptions for them are omitted.

FIG. 3A schematically shows an example of the organic film forming apparatus 22. The organic film forming apparatus 22 has the feeder 32, the application device 26, the heating device 28, the UV irradiation device 30 and the winder 34. This organic film forming apparatus 22 forms the organic film in a roll-to-roll manner between the feeder 32 and the winder 34. A line sensor 31 and an image processor 37 electrically connected to the line sensor 31 are disposed between the UV irradiation device 30 and the winder 34 to inspect the surface of the supporting member 12.

After forming of the organic film on the supporting member 12, an image of the surface of the organic film is taken with the line sensor 31. The image processor 37 processes a signal from the line sensor 31 to detect the existence/nonexistence of a flaw or the like. Since the black laminate film is adhered to the back surface side of the supporting member 12, it is possible to sense the surface of the supporting member 12 without being affected by reflection of light. Since a self-supporting property is imparted to the supporting member 12 with the laminate film, knicking of the supporting member 12 is prevented. In an inspection step, the surface of the supporting member 12 can be accurately inspected.

In the present embodiment, the supporting member 12 having the laminate film on the back surface and having a self-supporting property is wound into the shape of a roll and prepared as the film roll 40. A self-supporting property is imparted to the supporting member 12 with the laminate film. During transport from the feeder 32 to the winder 34, therefore, any longitudinal creases, folds or the like are not caused in the supporting member 12. Prevention of breakage of the organic film formed on the supporting member 12 is thus enabled. In particular, through prevention of breakage of the organic film before forming of the inorganic film, prevention of occurrence of a film forming failure region (i.e., a defect) in the inorganic film is enabled.

Even in a case where a defect or the like occurs in the organic film on the supporting member 12, the supporting member 12 can be accurately inspected since the laminate film is black in color. By detecting the existence/nonexistence of flaws or the like during transport, the manufacturing loss is reduced. Prevention of flow of the supporting member having a defect to a downstream process is also enabled thereby.

In the present embodiment, inspection is performed with the line sensor 31 and the image processor 37. However, the present invention is not limited to this. For example, inspection with the eye may alternatively be performed.

As shown in FIG. 3B, the vacuum film forming apparatus 24 is an apparatus for performing film forming in a roll-to-roll manner, as is the organic film forming apparatus 22. The supporting member 12 is fed from the film roll 42 by the feeder 56. The inorganic film is formed on the organic film on the supporting member 12 while the supporting member 12 is being transported in the lengthwise direction. The supporting member 12 on which the laminate formed of the organic film and the inorganic film is formed is wound into the film roll 48 by the winder 58. The vacuum film forming apparatus 24 is provided with the supply chamber 50, the film forming chamber 52 and the winding chamber 54.

As shown in FIG. 3B, the supporting member 12 is fed from the film roll 42 and is transported from the supply chamber 50 into the film forming chamber 52 through the slit 74a in the partition wall 74. In the supply chamber 50, the feeder 56 is rotated clockwise as viewed in the figure by a drive source (not shown). The supporting member 12 is transported from the film roll 42 into the film forming chamber 52 through a predetermined path by the guide roller 60. The supporting member 12 has the organic film on its front surface side and the laminate film adhered to its back surface. The supporting member 12 has the self-supporting property imparted with the laminate film.

Further, the line sensor 31 and the image processor 37 disposed in the organic film forming apparatus 22 may be disposed in the vacuum film forming apparatus 24. For example, the line sensor 31 and the image processor 37 are disposed between the feeder 56 and the drum 62 to enable inspection of the state of the surface of the organic film before forming of the inorganic film. Also, the line sensor 31 and the image processor 37 may be disposed between the drum 62 and the winder 58 to inspect the state of the surface of the inorganic film.

The laminate film is provided on the back surface of the supporting member 12 to impart suitable rigidity to the supporting member 12, on which the inorganic film is formed. The supporting member 12 can be transported through the vacuum film forming apparatus 24 (or moved forward and backward a certain number of times) without causing any longitudinal creases or folds. Thus, prevention of occurrence of defects in the inorganic film due to film forming failures is enabled and the inorganic film can be obtained with improved quality.

FIG. 4A shows the state of the supporting member 12 during transport before forming of the inorganic film. In each of the stepped guide rollers 60 and 68, two end portions are larger in diameter than a central portion. The organic film 14 contacts only the two end portions of the guide rollers 60 and 68. The region of the organic film 14 actually used as a product (actually functioning portion) does not contact the guide rollers 60 and 68. In particular, since the black laminate film 20 is adhered to the back surface of the supporting member 12, longitudinal creases or folds cannot be easily caused in the supporting member 12 even when a tension is applied to the supporting member 12. The actually functioning portion of the organic film 14 has improved surface smoothness and surface characteristics without being deteriorated in performance and characteristics. Therefore, the performance of the inorganic film 16 formed on the organic film 14 is not impaired.

FIG. 4B shows the state of the supporting member 12 during transport after forming of the inorganic film. In each of the stepped guide rollers 70 and 78, two end portions are larger in diameter than a central portion. The inorganic film 16 contacts only the two end portions of the guide rollers 70 and 78. The actually functioning portion of the inorganic film 16 does not contact the guide rollers 70 and 78. Since the black laminate film 20 is adhered to the back surface of the supporting member 12, longitudinal creases or folds cannot be easily caused in the supporting member 12. Therefore, the actually functioning portion of the inorganic film 16 has no reductions in performance and characteristics due to cutouts or the like.

Since the self-supporting property is imparted to the supporting member, the speed of transport of the supporting member can be increased even when the supporting member is supported only by the end portions of the stepped guide rollers. Also, the stability of transport can be remarkably improved.

In ordinary cases of using stepped guide rollers, the tension for transport cannot be increased because of the existence of the steps. In particular, if the supporting member does not have a sufficiently high self-supporting property, it can bend easily at its central portion and, therefore, the upper limit value of the tension is reduced. On the other hand, increasing the transport speed requires increasing the tension, which is necessary for elimination of slippage as well. It is possible to prevent bending even under a certain tension by improving the self-supporting property with the laminate film formed on the back surface side, and to thereby enable increasing the speed of transport of the supporting member. With the higher self-supporting property, the amount of deformation at the stepped portions is reduced, meandering and variation in tension are eliminated and the stability (accuracy) of transport is improved.

Next, as shown in FIG. 3B, the film roll 48 is set as the film roll 40 in the feeder 32 in the organic film forming apparatus 22 and the organic film is formed on the inorganic film. The supporting member 12 on which the organic film, inorganic film and organic film are formed is wound as the film roll 42 by the winder 34. Before the supporting member 12 is wound as the film roll 42 by the winder 34, the surface of the supporting member 12 can be inspected with the line sensor 31 and the image processor 37.

Forming of the film the organic material and forming the film of the inorganic material are repeated three times and a film of the organic material is formed in the outermost layer, thus manufacturing the functional film shown in FIG. 1.

After the completion of forming of the predetermined organic film and inorganic film on the supporting member, the laminate film can be separated from the supporting member, if no inspection step is required. This is because the laminate film is adhered to the back surface of the supporting member not for the purpose of protecting the supporting member but for the purpose of securing the desired self-supporting property during the film forming process and performing inspection during transport.

The laminate film is adhered to impart the self-supporting property to the supporting member in the present embodiment in contrast with the case where the supporting member itself is increased in thickness to have the self-supporting property. Therefore, the laminate film can be separated at the time of product processing after making of the functional film. Since the supporting member is not increased in thickness in the case of imparting the self-supporting property by adhering the laminate film, the functional film can be manufactured at a lower cost in comparison with the case where the supporting member itself, provided at a high unit price, is increased in thickness. In a case where there is a need to reduce the thickness of the supporting member, the product can be manufactured without reducing the production efficiency since the desired self-supporting property is imparted by adhering the laminate film. The supporting member reduced in thickness can be provided by separating the laminate film after manufacturing.

Both securing the self-supporting property and securing the inspection facility can be achieved by providing the black laminate film.

In particular, the influence of attachment of a foreign material to the smooth surface on the supporting member before forming of the inorganic film is considerable with respect to a failure in forming of the inorganic film, which may occur thereafter. The smooth surface on the supporting member means the surface of the supporting member in the case where the inorganic film is formed directly on the supporting member, and means the surface of the organic film in the case where the organic film is formed on the supporting member. There is a need for improving the transport accuracy with respect to how the supporting member before forming of the inorganic film is protected. For improvement in the transport accuracy, not only adhering the laminate film from the viewpoint of protection but also paying attention to the self-supporting property (rigidity) is required and the total thickness as the sum of the thickness of the supporting member on which the inorganic film is formed and the thickness of the laminate film is also important.

It is preferable to process the supporting member and the laminate film through a step for improving the force of adhesion between the supporting member and the laminate film before forming of the inorganic film. It is preferable to perform processing through a heating zone and/or an ultraviolet curing zone as a step for improving the force of adhesion. The supporting member with the laminate film may be passed through a heating zone and/or an ultraviolet curing zone provided before the vacuum film forming apparatus. Alternatively, the heating device 28 and the UV irradiation device 30 in the organic film forming apparatus 22 shown in FIG. 3A may be used as an adhesion-force-improving step. When this step is performed, the supporting member with the laminate film is wound by the winder 34 while a certain tension (about 50 to 500 N/m) is applied by the transport devices. The supporting member and the laminate film wound while receiving heat have improved adhesion therebetween as a result of pressure contact with the take-in rollers 36 such as to be not easily separable or deformable when handled during vacuum film forming.

The same material for the organic film as that in the first embodiment can be used. The same method of forming the organic film as that in the first embodiment can be used. As the inorganic film, a suitable film can be selected according to the purpose with which the functional film is provided, as in the first embodiment.

### EXAMPLES

The present invention will be described in more detail with respect to concrete examples thereof.

### Example 1

PET bases having a width of 1000 mm and differing in thickness were used as supporting members. Laminate films of several thicknesses for imparting a self-supporting property were prepared. Supporting members with laminate films were prepared by adhering PET laminate films to back surfaces of the PET bases.

In a case where adhesion-improving processing was performed before loading in the inorganic film forming apparatus, the processing was performed by feeding the supporting member with laminate film, passing the supporting member with laminate film through a heating zone and/or an ultraviolet curing zone, and thereafter winding the supporting member with laminate film. More specifically, the supporting member with laminate film was set in roll form in the feeder, passed through the heating zone or the ultraviolet curing zone (or both the heating zone and the ultraviolet curing zone) and wound while being stretched at a constant tension (about 50 to 500 N/m) by the transport devices. Simultaneously, 1 μm organic film was formed on the supporting member.

The roll of the supporting member with laminate film made in this way as set in the feeder in the vacuum film forming apparatus, vacuum pumping was performed, and an alumina film was formed to a desired thickness by using reactive sputtering. The performances of the manufactured functional films were evaluated by using water vapor permeability. Also, the number of occurrences of creases due to transport was recognized by evaluation with the eye. The water vapor permeability was evaluated on the basis of the criteria shown in Table 1.

TABLE 1

| | Evaluation |
|---|---|
| Performance (Water vapor permeability) | criteria |
| Equal to or higher than 1.0 × 10⁻³ g/m² · day | D |
| Equal to or higher than 2.0 × 10⁻⁴ g/m² · day and lower than | C |
| 1.0 × 10⁻³ g/m² · day | |
| Equal to or higher than 1.0 × 10⁻⁴ g/m² · day and lower than | B |
| 2.0 × 10⁻⁴ g/m² · day | |
| Lower than 1.0 × 10⁻⁴ g/m² · day | A |

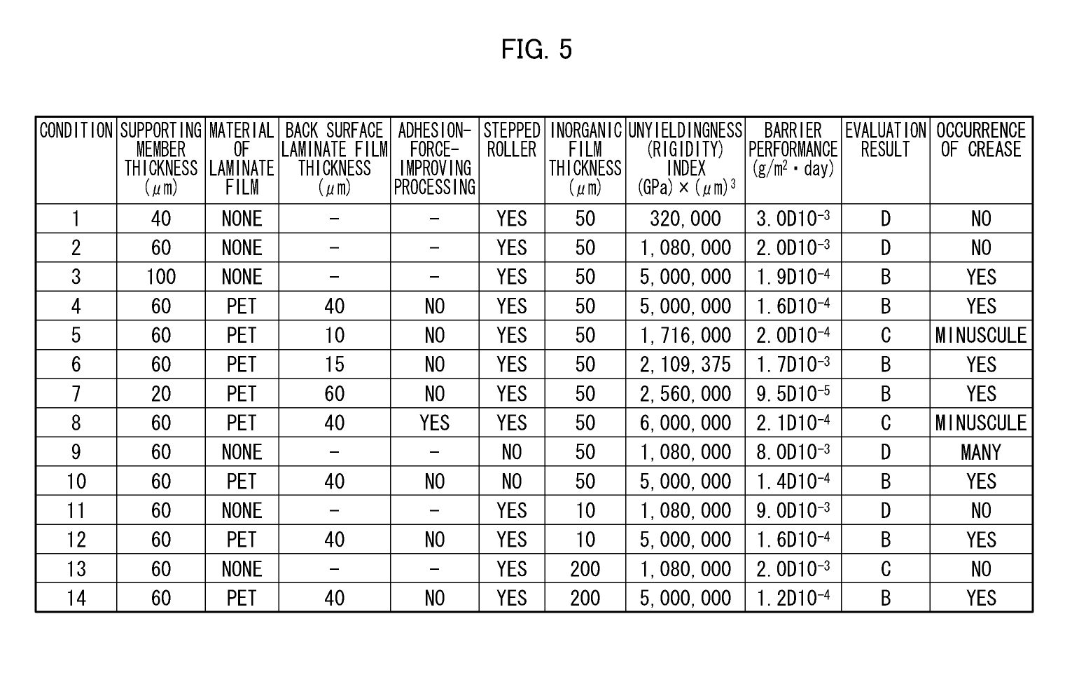

FIG. 5 shows a table of conditions including the supporting member thickness (μm), the laminate film material, the back surface laminate film thickness (μm) and the execution/nonexecution of adhesion-force-improving processing and the results of evaluation of the self-supporting property with respect to Conditions 1 to 14.

### Condition 1

The thickness of the supporting member was set to 40 μm. Nonstepped cylindrical rollers were used as the guide rollers for transport of the supporting member in the vacuum film forming apparatus. 50 nm inorganic film was formed on the supporting member.

### Condition 2

Same as Condition 1 except that the thickness of the supporting member was set to 60 μm.

### Condition 3

Same as Condition 1 except that the thickness of the supporting member was set to 100 μm.

### Condition 4

The thickness of the supporting member was set to 60 μm. 40 μm laminate film was adhered to the back surface of the supporting member. Adhesion-force-improving processing was performed before setting in the vacuum film forming apparatus after adhering the laminate film to the supporting member. Nonstepped cylindrical rollers were used as the guide rollers for transport of the supporting member in the vacuum film forming apparatus. 50 nm inorganic film was formed on the supporting member.

### Condition 5

Same as Condition 4 except that the thickness of the laminate film was set to 10 μm.

### Condition 6

Same as Condition 4 except that the thickness of the laminate film was set to 15 μm.

### Condition 7

Same as Condition 4 except that the thickness of the supporting member was set to 20 μm and the thickness of the laminate film was set to 60 μm.

### Condition 8

Same as Condition 4 except that adhesion-force-improving processing was not performed.

### Condition 9

Same as Condition 2 except that stepped rollers were used as the guide rollers.

### Condition 10

Same as Condition 4 except that stepped rollers were used as the guide rollers.

### Condition 11

Same as Condition 2 except that the thickness of the inorganic film was set to 10 nm.

### Condition 12

Same as Condition 4 except that the thickness of the inorganic film was set to 10 nm.

### Condition 13

Same as Condition 2 except that the thickness of the inorganic film was set to 100 nm

### Condition 14

Same as Condition 4 except that the thickness of the inorganic film was set to 100 nm

### <Evaluation>

The barrier performances under Conditions 1, 2, 9, and 11 were evaluated as “D”, since the thickness of each supporting member was 60 μm or less, and since no laminate film was adhered. Further, creases were recognized in the supporting members. Under Condition 9 including use of the stepped rolls in particular, the number of occurrences of creases was large. In the case of supporting only the end portions of the supporting member having substantially no self-supporting property with the stepped rolls, may longitudinal creases caused by the tension occurred.

The barrier performance under Condition 3 was evaluated as “A”, since the thickness of the supporting member was comparatively large, 100 μm. No occurrence of creases under Condition 3 was recognized.

In Conditions 4 to 8, 10, 12, and 14, the laminate film was adhered to the back surface of the supporting member. With respect to these conditions, the barrier performance was evaluated as “C” or higher, and substantially no creases were recognized. The results in terms of barrier performance and occurrence of creases obtained from Conditions 4 to 6 were such that, when the thickness of the supporting member was not changed, the larger the thickness of the laminate film, the better the results.

From Condition 7, even though the thickness of the supporting member was small, good results in terms of barrier performance and occurrence of creases were obtained because of the larger laminate film thickness. From the table in FIG. 5, it can be understood that good results in terms of barrier performance and occurrence of creases can be obtained when the total thickness of the supporting member and the laminate film is 75 μm or more.

In comparison between the results from Conditions 4 and 8, the results from Condition 4 including adhesion-force-improving processing were better than those from Condition 8. In the case where adhesion-force-improving processing was not performed, the barrier performance was reduced and minuscule creases due to separation of the laminate film was observed.

With respect to Condition 10, in comparison with Condition 9 under which a large number of occurrences of creases was recognized, no creases occurred in the supporting member having the higher self-supporting property even when the stepped guide rollers were used. It can be understood that, in the case of using the stepped guide rollers, the supporting member has an influence on the performance of the inorganic film if the self-supporting property of the supporting member is low. That is, it can be understood that it is useful to adhere the laminate film to the back surface of the supporting member in order to secure the desired self-supporting property.

In Conditions 2, 4, and 11 to 14, the film thickness of the inorganic film was changed for the purpose of evaluating whether or not the thickness of the inorganic film influences the self-supporting property. Conditions 2, 11, and 13 are the same except that the thickness of the inorganic film was changed. Conditions 4, 12, and 14 are the same except that the thickness of the inorganic film was changed. Conditions 2 and 4 differ from each other in existence/nonexistence of the laminate film and in execution/nonexecution of adhesion-improving processing. Conditions 11 and 12 differ from each other in the same respects, and Conditions 13 and 14 also differ from each other in the same respects. As can be understood from the table, with respect to Conditions 2, 11, and 13, the thinner the inorganic film, the worse the barrier performance evaluation result. On the other hand, with respect to Conditions 4, 12, and 14, good results were obtained both in terms of barrier performance and in terms of occurrence of creases, since the laminate films were provided, although little differences in barrier performance were recognized. The smaller the thickness of the inorganic film, the more important impartment of the self-supporting property for reducing damage (adhering the laminate film).

### Example 2

Polycarbonate (PC) bases having a width of 1000 mm and differing in thickness were used as supporting members. 60 μm thick laminate films formed of several materials for imparting solvent resistance were prepared. Supporting members with laminate films were prepared by adhering laminate films having solvent resistance to back surfaces of the PC bases.

The solvent resistances of the laminate films used on the back surface were tested on the basis of JIS K 5600-6-1. Test pieces were immersed in several solvents, and creases, swelling and cracks in coating films, separation of the coating films, changes in color and gloss, increases in viscosity, changes in swelling, softening and elution, coloring of the solution, existence/nonexistence of turbidity and degrees of turbidity were examined. In this experiment, the degree of permeation when immersed in a ketone-based solvent was used as an index. For comparison in performance in protection of the supporting members on which barrier films were formed, laminate films formed of materials shown below were selected.

More specifically, polycarbonate (PC), polypropylene (PP), polyethylene (PE), polyvinyl alcohol (PVA) and polyethylene terephthalate (PET) were selected. The resistance to the ketone-based solvent was evaluated on the basis of JIS K 5600-6-1. The results of this evaluation were PC: “D”, PP: “C”, PE: “C”, PVA: “D”, and PET: “B”.

Organic and inorganic films were formed on the supporting members with laminate films and the supporting members with no laminate films, and the performances of the films were evaluated.

First, an acrylate monomer and a photopolymerization initiator were dissolved in an organic solvent and the solution was applied on each supporting member with a die coater. The coating film was dried and set by ultraviolet curing, thereby forming the organic film on the supporting member. A film roll was made while performing control with respect to the winding diameter such that the winding tension was constant. The rate of supply of the solution to the supporting member was controlled so that the thickness of the organic film was 1 μm in the completely set state.

The film roll into which the supporting member on which the organic film was formed was wound was left under the atmosphere for one hour or longer. Leaving under the atmosphere enables air between the laminate film and the organic layer to be released by the weight of the film roll. The film roll was thereafter set in the vacuum film forming apparatus. After vacuum pumping from the vacuum film forming apparatus, the inorganic film (alumina film) was formed to a thickness of 50 nm on the surface of the organic film by using reactive sputtering.

To clarify the influence in vacuum film forming, a mass distribution of gas in the film forming portion was measured by quadrupole mass spectrometry (Qmass).

The performances of the manufactured functional films were evaluated by using water vapor permeability. The water vapor permeability was evaluated on the basis of the criteria shown in Table 1.

The degree of influence of the solvent on the barrier film supporting member and the back surface laminate in the application process was determined by evaluation with the eye of whitening of portions eroded by the solvent. Evaluation with the eye was performed on the basis of criteria shown in Table 2.

TABLE 2

| Solvent damage to barrier film supporting member | Evaluation |
|---|---|
| (application) | criteria |
| Whitened almost entirely | E |
| Many occurrences of whitened portions | D |
| Sparse occurrences of whitened portions | C |
| None | B |

The instability of film forming due to the influence of outgasing was determined on the basis of a criterion described below as well as measurements by Qmass. More specifically, the film thickness of the inorganic film after the completion of actual film forming was measured and the instability of film forming was determined through the amount of change in the film forming rate with respect to the setting. A range of ±10% of the film thickness was set as a range of normal values.

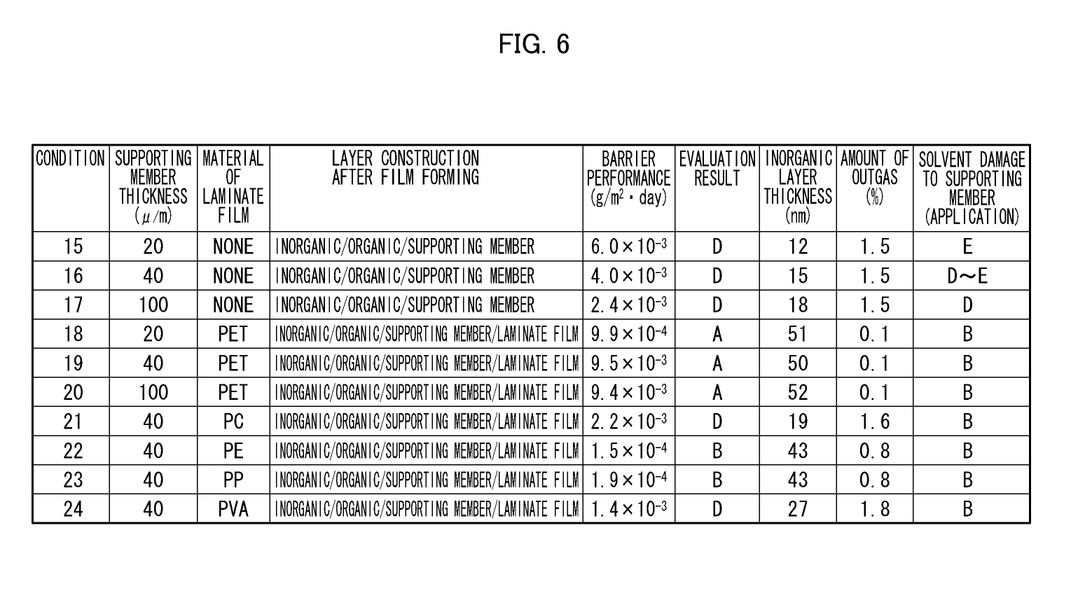

FIG. 6 shows a table of conditions of the supporting members and the laminate films in conditions 15 to 25 and evaluation results with respect to Conditions 15 to 24.

### Condition 15

The thickness of the supporting member was set to 20 μm, and no laminate film was adhered to the back surface of the supporting member. The organic film and the inorganic film were formed in this order on the front surface of the supporting member.

### Condition 16

Same as Condition 15 except that the thickness of the supporting member was set to 40 μm.

### Condition 17

Same as Condition 15 except that the thickness of the supporting member was set to 100 μm.

### Condition 18

The thickness of the supporting member was set to 20 μm and the laminate film formed of PET was adhered to the back surface of the supporting member. The organic film and the inorganic film were formed in this order on the front surface of the supporting member.

### Condition 19

Same as Condition 18 except that the thickness of the supporting member was set to 40 μm.

### Condition 20

Same as Condition 18 except that the thickness of the supporting member was set to 100 μm.

### Condition 21

Same as Condition 19 except that the laminate film formed of PC was adhered to the back surface of the supporting member.

### Condition 22

Same as Condition 19 except that the laminate film formed PE was adhered to the back surface of the supporting member.

### Condition 23

Same as Condition 19 except that the laminate film formed of PP was adhered to the back surface of the supporting member.

### Condition 24

Same as Condition 19 except that the laminate film formed of PVA was adhered to the back surface of the supporting member.

### <Evaluation>

The amount of outgas (%) shown in the table of FIG. 6 represents the percent by weight of the amount of MEK detected by Qmass when the amount of oxygen put in to form alumina is 100.

In the vicinity of film forming, the amount of oxygen as reactive gas is important. Therefore the proportion of the amount of outgas was computed with reference to the amount of oxygen.

With respect to Conditions 15 to 17, since no laminate film was provided, each of the evaluation result and the solvent damage was “D”. In the case where no laminate film was provided, the supporting member deformed as a result of solvent damage. Therefore the inorganic film was not correctly formed and the barrier performance was evaluated as “D”. Also, by solvent damage, the supporting member was whitened to be unusable. Whitening was more noticeable when the thickness is particularly small.

With respect to Conditions 18 to 20, when the laminate film formed of PET was used, the solvent damage was “B” and the barrier performance was evaluated as “A” irrespective of the thickness of the supporting member.

With respect to Condition 21, the evaluation result was “D”, while the solvent damage was “B” because of use of PC for the laminate film. With respect to Conditions 22 and 23, each of the barrier performance and the solvent damage was evaluated as “B”. With respect to Condition 24, the evaluation result was “D”, while the solvent damage was “B” because of use of PVA for the laminate film.

In Condition 21, PC having low solvent resistance was adhered as the laminate film to the back surface. As a result, PC was damaged by solvent. On the other hand, the supporting member was protected by PC on the back surface from being damaged by the solvent. The solvent damage was therefore evaluated as “B”. However, since PC has low solvent resistance, it was whitened and absorbed the solvent. At the time of film forming of the inorganic film, therefore, gas was released from PC, so that the film thickness of the inorganic film was small (19 nm) and the barrier performance was low. The amount of outgas at this time was 1.6%. The evaluation result was “D”.

In Condition 24, PVA having low solvent resistance was adhered as the laminate film to the back surface. As a result, the evaluation result with respect to the barrier performance was “D”, while the solvent damage was evaluated as “B”. The film thickness of the inorganic film was 29 nm and the amount of outgas was 1.8%.

As can be understood from these results, the organic film can be formed to a sufficiently large thickness by setting the amount of outgas to 1% or less. High barrier performance can be obtained thereby.

### Example 3

PET bases having a width of 1000 mm and differing in thickness were used as supporting members. Black laminate films (PET base) of several thicknesses for imparting a self-supporting property and for enabling inspection were prepared. Supporting members with laminate films were prepared by adhering the black laminate films to back surfaces of the supporting member PET bases. As the black PET base, Kukkirimieru (transliteration), a product from Tomoegawa Co., Ltd. (layer structure: protective film/adhesive layer/black ink/PET) was used. The protective film is separated at the time of adhesion to the back surface of the supporting member.

For comparison, a supporting member to which a transparent laminate film (TRETEC 7332 from Toray Industries, Inc.) was adhered was also prepared.

An acrylate monomer and a photopolymerization initiator were dissolved in an organic solvent and the solution was applied on each supporting member with a die coater. The coating film was dried and set by ultraviolet curing, thereby forming the organic film on the supporting member. A film roll was made while performing control with respect to the winding diameter such that the winding tension was constant. The rate of supply of the solution to the supporting member was controlled so that the thickness of the organic film was 1 μm in the completely set state.

The organic films formed under various conditions were formed on the supporting members. Each film roll into which the supporting member was wound was left under the atmosphere for one hour or longer. Leaving under the atmosphere enables air between the laminate film and the organic layer to be released by the weight of the film roll. The film roll was thereafter set in the vacuum film forming apparatus. After vacuum pumping from the vacuum film forming apparatus, the inorganic film (alumina film) was formed on the surface of the organic film by using reactive sputtering.

The performances (barrier performances) of the manufactured functional films were evaluated by using water vapor permeability. The degrees of line defects caused by transport were evaluated with the eye. The water vapor permeability was evaluated on the basis of the criteria shown in Table 1.

With respect to evaluation (detection) with the eye, a case where a line defect in the organic film surface was detectable was indicated by “B”, while a case where a line defect in the organic film surface was not detectable was indicated by “D”.

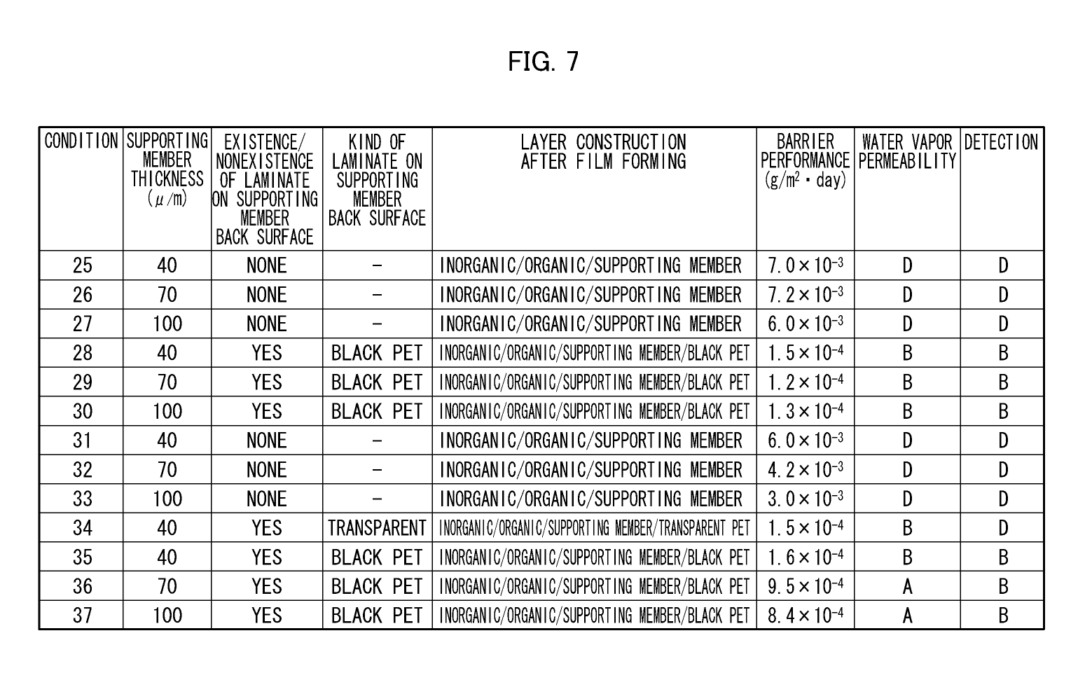

FIG. 7 shows a table of the supporting member thickness (w), the existence/nonexistence of the laminate film, colors, the results of evaluation of vapor permeability and the results of detection with respect to conditions 25 to 37.

### Condition 25

The thickness of the supporting member was set to 40 μm, and no laminate film was adhered to the back surface of the supporting member. Nonstepped guide rollers were used for transport of the supporting member from the state after forming of the organic film to forming of the inorganic film in the vacuum film forming apparatus. The inorganic film was formed to 50 nm on the supporting member.

### Condition 26

Same as Condition 25 except that the thickness of the supporting member was set to 70 μm.

### Condition 27

Same as Condition 25 except that the thickness of the supporting member was set to 100 μm.

### Condition 28

The thickness of the supporting member was set to 40 μm. The laminate film formed of black PET was adhered to the back surface of the supporting member. The inorganic film was formed to 50 nm on the supporting member. Stepped guide rollers were used for transport of the supporting member from the state after forming of the organic film to forming of the inorganic film in the vacuum film forming apparatus.

### Condition 29

Same as Condition 28 except that the thickness of the supporting member was set to 70 μm.

### Condition 30

Same as Condition 28 except that the thickness of the supporting member was set to 100 μm.

### Condition 31

The thickness of the supporting member was set to 40 μm. No laminate film was adhered to the back surface of the supporting member. Stepped guide rollers were used for transport of the supporting member from the state after forming of the organic film to forming of the inorganic film in the vacuum film forming apparatus. The inorganic film was formed to 50 nm on the supporting member.

### Condition 32

Same as Condition 31 except that the thickness of the supporting member was set to 70 μm.

### Condition 33

Same as Condition 31 except that the thickness of the supporting member was set to 100 μm.

### Condition 34

The thickness of the supporting member was set to 40 μm. The laminate film formed of transparent PET was adhered to the back surface of the supporting member.

The inorganic film was formed to 50 nm on the supporting member. Stepped guide rollers were used for transport of the supporting member from the state after forming of the organic film to forming of the inorganic film in the vacuum film forming apparatus.

### Condition 34

The thickness of the supporting member was set to 40 μm. The laminate film formed of black PET was adhered to the back surface of the supporting member. The inorganic film was formed to 50 nm on the supporting member. Stepped guide rollers were used for transport of the supporting member from the state after forming of the organic film to forming of the inorganic film in the vacuum film forming apparatus.

### Condition 36

Same as Condition 35 except that the thickness of the supporting member was set to 70 μm.

### Condition 37

Same as Condition 35 except that the thickness of the supporting member was set to 100 μm.

### <Evaluation>

With respect to Conditions 25 to 27, since no black laminate film was provided on the back surface, each of the result of evaluation of the water vapor permeability (barrier performance) and the result of detection was “D”. With respect to Conditions 28 to 30, since the black laminate film was provided on the back surface, each of the result of evaluation of the water vapor permeability and the result of detection was “B”.

With respect to Conditions 31 to 33, since no black laminate film was provided on the back surface, each of the result of evaluation of the water vapor permeability (barrier performance) and the result of detection was “D”. In Condition 34, the transparent laminate film was provided on the back surface. As a result, the water vapor permeability (barrier performance) was evaluated as “B”. However, since the laminate film was transparent, the result of detection was “D”.

With respect to Condition 35, since the black laminate film is provided, each of the result of evaluation of the water vapor permeability (barrier performance) and the result of detection was “B”. With respect to Conditions 36 and 37, since the thickness of the supporting member is large, the water vapor permeability (barrier performance) was evaluated as “A”. According to Conditions 31 to 33, the barrier performance with respect to the supporting member without the laminate film was lower when stepped guide rollers were used. With respect to thinner supporting members, it can be said that the merit of adhering the black laminate film to the back surface is high.

What is claimed is:

1. A method of manufacturing a functional film, comprising the steps of:
supplying a lengthwise supporting member having a laminate film provided on a back surface side of the supporting member and having a self-supporting property;
forming a film of an inorganic material on a front surface side of the supporting member while transporting the supporting member under a vacuum; and
winding the supporting member.

2. The method according to claim 1, wherein the total thickness of the laminate film and the supporting member is 75 μm or more.

3. The method according to claim 1, further comprising the step of improving an adhesion between the supporting member and the laminate film before the step of forming the film of the inorganic material.

4. The method according to claim 3, wherein the step of improving the adhesion includes at least one of the steps of heating the supporting member and the laminate film while applying a predetermined tension to the supporting member, and applying ultraviolet rays to the supporting member and the laminate film while applying a predetermined tension to the supporting member.

5. The method according to claim 1, wherein, in the step of forming the film of the inorganic material, the supporting member is transported by supporting end portions of the supporting member on at least one of the back surface side and the front surface side of the supporting member.

6. The method according to claim 1, wherein, in the step of forming the film of the inorganic material, a thickness of the film of the inorganic material is equal to or larger than 5 nm and equal to or smaller than 200 nm.

7. The method according to claim 1, further comprising the step of forming a film of an organic material on the front surface side of the supporting member before the step of forming the film of the inorganic material.

8. The method according to claim 7, wherein the step of forming the film of the organic material and the step of forming the film of the inorganic material are repeated.

9. The method according to claim 1, further comprising the step of forming the organic material as an outer layer on the front surface side of the supporting member.

10. The method according to claim 1, further comprising the step of separating the laminate film from the supporting member.

11. The method according to claim 1, wherein the inorganic material includes at least one of a metal, a metal oxide, a metal nitride, a metal carbide, a metal fluoride, and a composite material formed of some of the metal, the metal oxide, the metal nitride, the metal carbide and the metal fluoride.

12. A method of manufacturing a functional film, comprising:
a first step of feeding a lengthwise supporting member having a laminate film having solvent resistance and provided on the back surface side of the supporting member, and applying a coating solution containing a solvent on the front surface side of the supporting member, and drying and setting the coating solution to form an organic film while transporting the supporting member; and
a second step of forming an inorganic film on the organic film while transporting under a reduced pressure the supporting member on which the organic film is formed.

13. The method according to claim 12, wherein the solvent comprises at least one solvent selected from the group consisting of acetone, methyl ethyl ketone, methyl isobutyl ketone, cyclohexanone, ethanol, methanol, isopropanol, tetrahydrofuran, propylene glycol monomethylether acetate, toluene, xylene and dichloroethane, and the laminate film has resistance to the solvent selected from the group.

14. The method according to claim 13, wherein the laminate film is constituted by one of polypropylene, polyethylene, and polyethylene terephthalate, or a combination of at least two of polypropylene, polyethylene and polyethylene terephthalate.

15. The method according to claim 14, wherein, in the second step of forming the inorganic film on the organic film, the amount outgas from the supporting member is 1% or less of the amount of gas introduced to form the inorganic film.

16. The method according to claim 12, wherein the first step and the second step include transporting the supporting member by supporting only end portions of the supporting member on the front surface side with a path roller.

17. The method according to claim 12, wherein each of the first step and the second step is repeated a predetermined number of times.

18. The method according to claim 12, wherein the inorganic film has a thickness equal to or larger than 5 nm and equal to or smaller than 200 nm.

19. The method according to claim 12, wherein the inorganic material includes a material selected from the group consisting of a metal, a metal oxide, a metal nitride, a metal carbide, a metal fluoride, and a composite material formed of some of the metal, the metal oxide, the metal nitride, the metal carbide and the metal fluoride.

20. The method according to claim 12, wherein the organic film includes one of a radiation-curing monomer and a radiation-curing oligomer.

21. A method of manufacturing a functional film, comprising:
a first step of feeding a lengthwise supporting member having a black laminate film provided on a back surface side of the supporting member and having self-supporting property, and forming an organic film on a front surface side of the supporting member while transporting the supporting member;
a second step of forming an inorganic film on the organic film while transporting the supporting member under a condition at a reduced pressure; and
a third step of inspecting a surface of the supporting member in the state of having the black laminate film provided.

22. The method according to claim 21, wherein the total thickness of the laminate film and the supporting member is 75 μm or more.

23. The method according to claim 21, wherein the black laminate film is a PET film.

24. The method according to claim 21, wherein the first step, the second step and the third step include transporting the supporting member by supporting only end portions of the supporting member on the front surface side with a path roller.

25. The method according to claim 21, wherein each of the first step, the second step and the third step is repeated a predetermined number of times.

26. The method according to claim 21, wherein the inorganic film has a thickness equal to or larger than 5 nm and equal to or smaller than 200 nm.

27. The method according to claim 21, wherein the inorganic material includes a material selected from the group consisting of a metal, a metal oxide, a metal nitride, a metal carbide, a metal fluoride, and a composite material formed of some of the metal, the metal oxide, the metal nitride, the metal carbide and the metal fluoride.

28. The method according to claim 21, wherein the organic film includes one of a radiation-curing monomer and a radiation-curing oligomer.
